(19) United States
(12) Patent Application Publication
(10) Pub. No.: US 2013/0119223 A1
(43) Pub. Date: May 16, 2013

(54) GARBAGE CAN HOLDER

(71) Applicant: WILLIE F. EVERSON, WEST POINT, MS (US)

(72) Inventor: WILLIE F. EVERSON, WEST POINT, MS (US)

(21) Appl. No.: 13/677,013

(22) Filed: Nov. 14, 2012

Related U.S. Application Data
(60) Provisional application No. 61/560,251, filed on Nov. 15, 2011.

(51) Int. Cl. F16M 13/00

(52) U.S. Cl. CPC F16M 13/00
USPC 248/545

(57) ABSTRACT

The garbage can holder has an elongate, telescoping rod that is staked into the ground. The rod has a sharp, pointed end for penetration into the ground, and a top portion forming at least one eye or aperture through which one or more steel or plastic hoops are looped. The hoops, which have locking ends, can be wrapped around garbage containers and then secured around the containers via the locking ends in order to stabilize the containers in an upright position, thereby tethering the containers to the stake so that the containers do not tip over or blow away in windy or inclement weather.

### CROSS-REFERENCE TO RELATED APPLICATION

This application claims the benefit of U.S. Provisional Patent Application Ser. No. 61/560,251, filed Nov. 15, 2011.

### BACKGROUND OF THE INVENTION

1. Field of the Invention

The present invention relates generally to anchoring devices, and particularly to a garbage can holder that holds garbage cans anchored to the ground so that the garbage cans don't tip over or blow away in wind and inclement weather.

2. Description of the Related Art

Trash receptacles, lawn furniture, and the like are often left outdoors, either temporarily or permanently. Such articles are prone to being blown over by the wind, knocked over by animals, or otherwise moved or tipped over. At best, this results in the inconvenience of having to set the article upright again. At worst, the contents of a trash can may be strewn across one's lawn, creating an unsightly mess and often requiring the expenditure of considerable time and effort to clean up. It would be desirable to provide a device that will keep articles left outdoors standing upright. Moreover, it would be desirable to provide a safety device that prevents the garbage cans from being blown in the road, thereby avoiding the potential for road accidents.

Thus, a garbage can holder solving the aforementioned problems is desired.

### SUMMARY OF THE INVENTION

The garbage can holder has an elongate, telescoping rod that is staked into the ground. The rod has a sharp lower portion for penetration into the ground, and a top portion forming at least one aperture or eye through which a steel band or bands is/are looped to form ring(s). The rings, having locking ends, can be wrapped around garbage containers and then secured around the containers via the locking ends in order to stabilize the containers in an upright position. The garbage can holder is designed to fold up the two rings to make the holder more compact for storage and store display, since the holder takes up less space when folded.

These and other features of the present invention will become readily apparent upon further review of the following specification and drawings.

### BRIEF DESCRIPTION OF THE DRAWINGS

FIG. 1 is an environmental, perspective view of a garbage can holder according to the present invention.

FIG. 2 is a perspective view of a garbage can holder according to the present invention.

FIG. 3 is a top view of a garbage can holder according to the present invention.

Similar reference characters denote corresponding features consistently throughout the attached drawings.

### DETAILED DESCRIPTION OF THE PREFERRED EMBODIMENTS

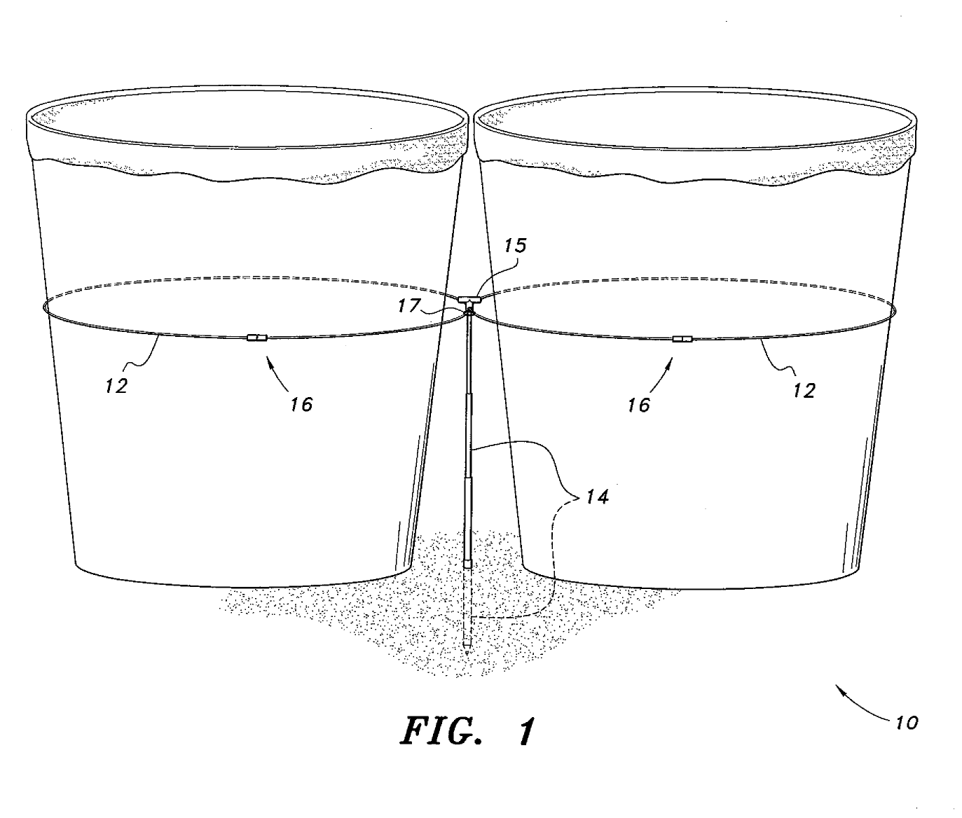

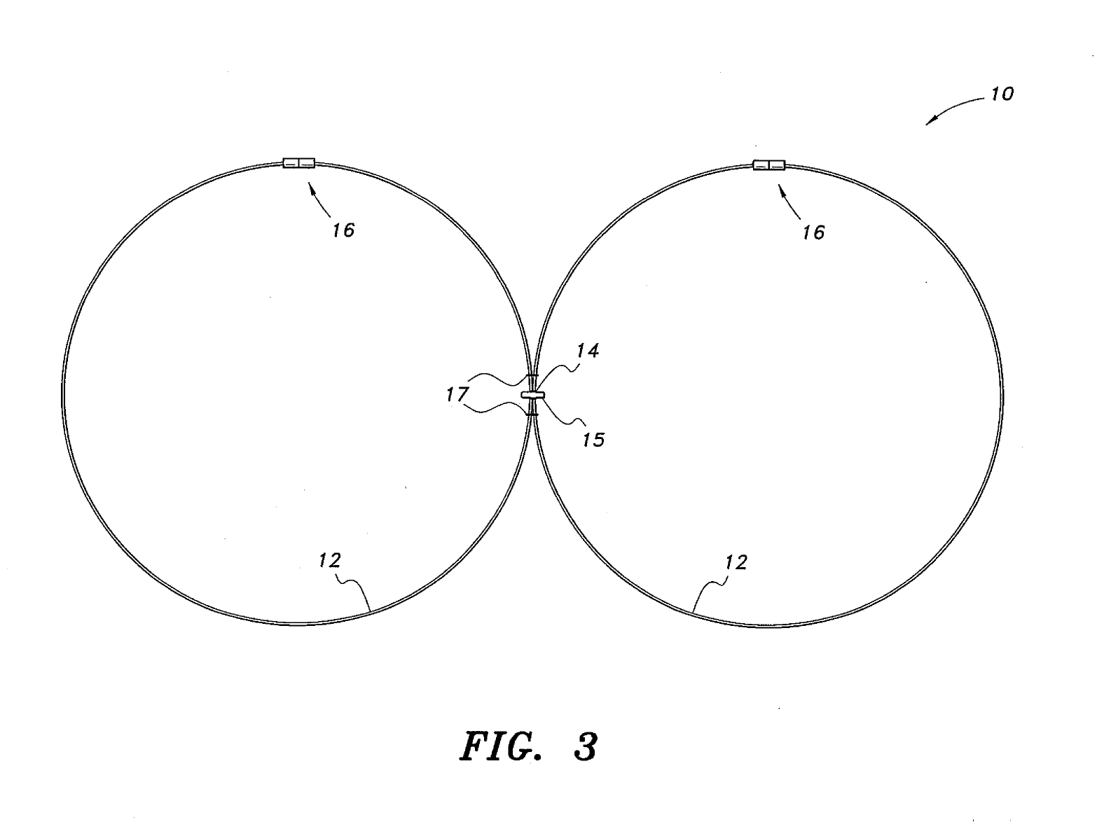

As shown in FIGS. 1-3, the garbage can holder 10 has an elongate, telescoping rod 14, which can be staked into the ground. The rod 14 has a sharp, pointed end for penetration into the ground, and a top portion forming at least one aperture, eye, or ring through which one or more substantially rigid metal or plastic bands are looped to form hoops or rings 12. The rod 14 has a bulbous, flat-surfaced knob that forms a head 15 at the top of the rod 14. The head 15 is provided for striking with a hammer or sledgehammer in order to pound the rod 14 into the ground. The hoops 12, which have locking ends 16, can be wrapped around garbage containers and then releasably secured around the containers via the locking ends 16 in order to stabilize the containers in an upright position.

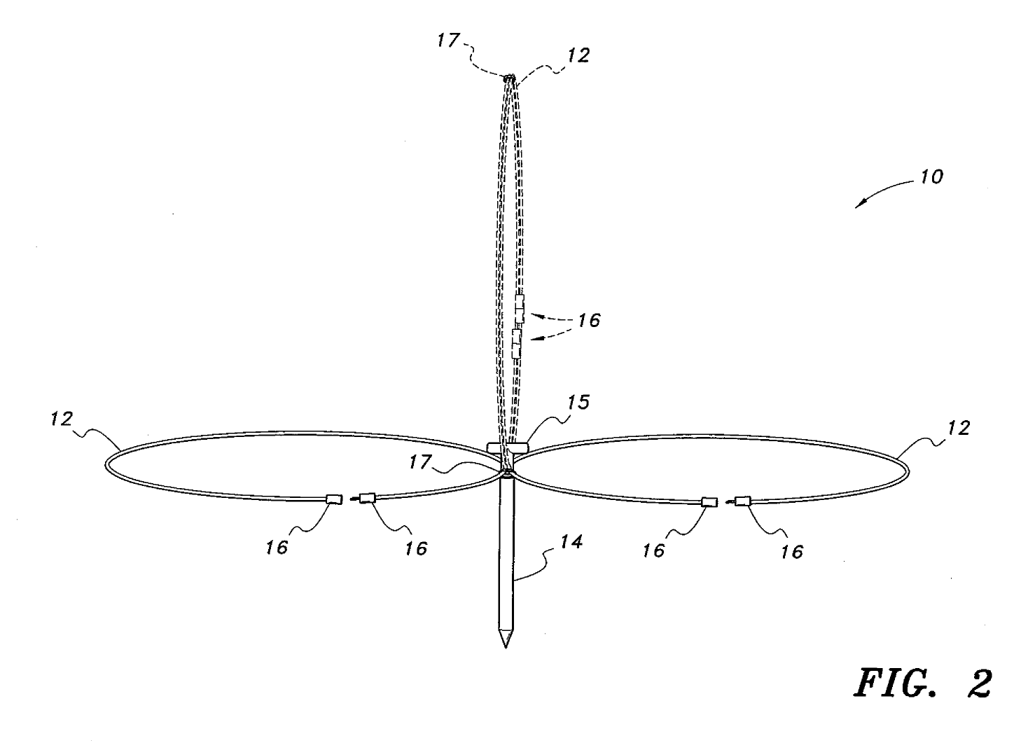

The hoops 12 are releasable at a user-selectable height so that the user does not have to lift the cans in order to place them inside the loop periphery. As most clearly shown in FIG. 2, the garbage can holder 10 is designed to fold up the two hoops 12 (being retained by retaining sliders 17) to make the holder 10 more compact for storage and store display. The holder 10 takes up less space when folded.

The hoop(s) 12 may be substantially rigid yet have sufficient elasticity to encircle garbage cans and refuse containers of different diameters. Alternatively, the hoop(s) 12 may be inelastic plastic or metal, substantially arcuate members that are furnished with locks, hook and loop, or other releasable fasteners that permit the hoop(s) to be formed into loops that are adjustable in diameter to accommodate cans of different diameter. Instead of hoops, other flexible elements, such as metal bands may be used to tether the garbage cans or containers to the rod or stake 14. In this case, the locking ends 16 may have hose clamps or other adjustable fasteners for cinching the band(s) around the garbage container.

The stake or rod 14 may be of fixed length, but is preferably telescoping so that the height above ground of the eye formed in the top end of the rod 14 can be adjusted to accommodate garbage can or containers of different heights. The length of the telescoping rod 14 may be fixed to keep the eye and the hoop 12 at the desired height above ground by twist-lock cams at the joints between adjacent sections of tubing, by clamps, by pins, or by any other means or mechanism for clamping telescoping sections of tubing together.

It is to be understood that the present invention is not limited to the embodiment described above, but encompasses any and all embodiments within the scope of the following claims.

I claim:

1. A garbage can holder, comprising:
an elongated rod having a sharp pointed tip at one end adapted for penetrating the ground and an opposing end having an eye formed therein;
at least one substantially arcuate element having opposing ends, the arcuate element extending through the eye of the rod; and
a locking mechanism attached to the opposing ends of the substantially arcuate element in order to form the substantially arcuate element into a hoop of adjustable diameter for tethering a garbage can to the rod, the rod being anchored in the ground.

2. The garbage can holder according to claim 1, wherein said rod further comprises telescoping members, thereby allowing said hoop to be releasable at a user-selectable height.

3. The garbage can holder according to claim 1, wherein said at least one arcuate element comprises two arcuate elements, each of the arcuate elements having a retainer slider securing the arcuate elements in a folded up, compact configuration for storage.

4. The garbage can holder according to claim 1, wherein said at least one substantially arcuate element is an elastic member.

5. The garbage can holder according to claim 1, wherein said at least one substantially arcuate element is an inelastic member.

6. The garbage can holder according to claim 1, wherein said locking member is adjustably positionable along said at least one substantially arcuate element to adjust the circumference of the hoop to accommodate the diameter of the garbage can.

7. The garbage can holder according to claim 1, wherein said rod further comprises telescoping members having twist-lock cams at joints between adjacent sections to retain the telescoping members at a user-selectable height.

8. A garbage can holder, comprising:
an elongated rod having a sharp, pointed tip at one end adapted for penetrating the ground and an opposing end having an eye formed therein;
at least one flexible member having opposing ends, the flexible member extending through the eye of the rod; and
a locking mechanism attached to the opposing ends of the flexible member in order to form the flexible member as an adjustable tether around a garbage can.

9. The garbage can holder according to claim 8, wherein said rod has telescoping members, thereby allowing the rod's height above ground to be adjusted.

10. The garbage can holder according to claim 8, wherein said flexible member is elastic.

11. The garbage can holder according to claim 8, wherein said flexible member is inelastic.

12. The garbage can holder according to claim 8, wherein said locking member is adjustably positionable along said flexible member to adjust the circumference of the tether to accommodate the diameter of the garbage can.

13. The garbage can holder according to claim 9, wherein said rod has telescoping members having twist-lock cams at joints between adjacent sections to retain the telescoping members at a user-selectable height above ground.
